(19) United States
(12) Patent Application Publication
(10) Pub. No.: US 2023/0198264 A1
(43) Pub. Date: Jun. 22, 2023

(54) ELECTRICAL ARCHITECTURE COMPRISING AT LEAST ONE LINEAR PHOTOVOLTAIC INSTALLATION FORMED BY SEVERAL GROUPS OF PHOTOVOLTAIC PANELS AND BY A DC NETWORK, CONNECTED TO AN AC TRANSMISSION NETWORK AND/OR AN AC DISTRIBUTION NETWORK WITH ARBITRATION OF THE POWER INJECTED FROM THE DC NETWORK TO THE AC NETWORK

(71) Applicant: COMMISSARIAT A L'ENERGIE ATOMIQUE ET AUX ENERGIES ALTERNATIVES, Paris (FR)

(72) Inventor: Quoc-Tuan TRAN, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/066,552

(22) Filed: Dec. 15, 2022

(30) Foreign Application Priority Data
Dec. 20, 2021 (FR) 21 14042

(51) Int. Cl. H02J 3/38; H02M 3/335

(52) U.S. Cl. CPC H02J 3/381; H02M 3/335; H02J 2300/24

(57) ABSTRACT

An electrical architecture including at least one linear photovoltaic installation formed by several groups of photovoltaic panels and by a DC network, connected to an AC transmission network and/or an AC distribution network with arbitration of the power injected from the DC network to the AC network. The system substantially entails putting in place an architecture with at least one linear PV installation with a DC network and interconnecting this subassembly at at least two separate points of interconnection with a preferably existing AC power grid. Each point of interconnection to a node of the AC network is a voltage source converter VSC which can inject 0 to 100% of the maximum power P of the linear PV installations.

### TECHNICAL FIELD

The present invention relates to the general field of power grids.

The invention more particularly concerns the interconnection between an alternating current (AC) transmission network and/or an alternating current (AC) distribution network and at least one linear photovoltaic installation.

“Linear PV installation” is understood here and in the context of the invention to mean photovoltaic panels arranged in groups according to a surface which extends mainly along a line and preferably on or along man-made ground such as cycle paths, edges of motorways, railway lines, etc, or natural ground, for example that not used for agricultural purposes.

Throughout the application, the following abbreviations are used for simplicity:

AC: Alternating Current;

DC: Direct Current;

MVDC: Medium Voltage Direct Current, typically in the range 30 to 150 kilovolts (kV);

HVDC: High Voltage Direct Current, typically greater than 150 kilovolts (kV);

VSC: Voltage Source Converter;

MMC: Modular Multi-Level Converter.

### PRIOR ART

In the context of high demand for renewable energy (REn) with the need for a dedicated power grid, typically up to 30% in 2030 in France and under expansion on the part of solar in the REn domain, there is a need to install numerous ground-based high-power solar photovoltaic (PV) power plants, typically of the order of a few hundreds of MW each.

The issue of the land available for this PV technology therefore becomes crucial. Specifically, with regard to the surface areas required, the deployment of large ground-based solar PV power plants can generate conflicts of use with agricultural land and affect biodiversity. For example, the most powerful solar PV power plant in France to date, with a power rating of 300 MW, is installed at Cestas, near Bordeaux, over an area of 260 hectares.

Finding new land to develop solar PV power plant projects has therefore become the main concern for developers of REn energy.

Furthermore, faced with the desire of public authorities to limit the use of large agricultural spaces for such ground-based PV power plants, ecologically acceptable alternatives must be found.

One solution which addresses this issue involves taking advantage of surfaces referred to as “linear”, in the form of man-made ground such as cycle paths, edges of motorways, railway lines, etc, or natural ground, for example that not used for agricultural purposes, such as along watercourses, and which extend over tens, or even hundreds, of kilometres, for installing high power PV systems. The advantages of these potential surfaces are that they are already very available, can be exploited directly in their unaltered state to install PV panels on them and are low cost since acquisition of land is not required.

The installation of new types of linear PV power plants/installations will therefore open up new opportunities in the PV development strategy. There are already a few linear PV installation projects in the world, but they are a priori of low power, typically a few kW. Moreover, very few articles on the design of these linear PV installations have been published.

Now, changing from PV power plants occupying tens or hundreds of hectares to linear PV installations extending over tens of hectometres or kilometres involves rethinking the entire related power grid architecture.

In general, the strategies of the European Union in the area of large-scale REn energy development highlights the important roles of electrical power infrastructure and sector coupling, i.e. interconnecting gas and electricity, in order to achieve a major decarbonisation of the economy.

There is therefore a need to propose an optimised technical solution for an electrical architecture which provides the very large number of connections of linear PV installations to the existing electrical power infrastructure.

The aim of the invention is therefore to address, at least in part, this need.

### DESCRIPTION OF THE INVENTION

To this end, the invention relates to, in one of its aspects, an electrical architecture comprising:
at least one linear installation comprising at least one group of photovoltaic (PV) panels, suitable for producing a maximum total power P, and
a direct current (DC) network comprising at least one bus, to which the group(s) of PV panels are electrically parallel-connected, each via a DC/DC converter,
an alternating current (AC) transmission and/or distribution network,
at least two voltage source converters (VSCs) (22), one of the two converters connecting the DC bus to a first node of the AC network, the other of the two converters connecting the DC bus to a second node of the AC network, separate from the first node, each of the VSCs being suitable for injecting 0 to 100% of the power P into the AC network,
a control system suitable for allocating the injection of power between the VSCs according to needs and/or operating conditions of the AC network, so as to reduce the total losses of the latter and/or improve the quality of service of the AC network, i.e. improve the capacity to respond to the needs of the AC network.

The possible control modes of the VSCs are:
Vac/f: Control of the voltage at the point of connection and of the frequency of the AC network
Vac-phi: Control of the voltage at the point of connection of the AC network and of the phase shift
Vdc-phi: Control of the voltage of the DC bus and of the phase shift
Vdc-Q: Control of the voltage of the DC bus and of the reactive power
PWM-phi: Control of the PWM modulation of the VSC and of the phase shift
P-Vac: Control of the injected power and of the voltage at the point of connection of the AC network
P-Q: Control of the active and reactive power injected into the AC network
Vdc-Vac: Control of the voltage of the DC bus and of the voltage at the connected point of the AC network
P-cos(f): Control of the active power injected into the AC network and of the power factor
Vdc-cos(f): Control of the voltage at the DC bus and of the power factor . . . .

Among all these control modes, the control modes P-Q; P-Vac are prioritised for the power injection allocation function according to the invention.

Advantageously, the VSCs are modular multi-level converters (MMCs).

According to an advantageous configuration, the bus, to which the group(s) of PV panels are directly electrically parallel-connected, is a medium voltage DC (MVDC) bus.

According to an advantageous variant embodiment, the architecture comprises several geographically distributed loads, such as high power electric vehicle charging stations or electrolysers for supplying hydrogen-operated vehicles, each connected via a DC/DC converter to the MVDC bus.

According to another advantageous variant embodiment, the architecture comprises several geographically distributed electrical storage means, such as batteries, each connected via a DC/DC converter to the MVDC bus.

According to another advantageous variant embodiment, the architecture comprises other geographically distributed current sources, such as wind turbines, each connected via a DC/DC converter to the MVDC bus.

According to an advantageous embodiment, the DC network of the linear installation comprises at least one high voltage DC (HVDC) bus connected to the medium voltage DC (MVDC) bus and to a voltage source converter (VSC) connected to a node of the AC network.

The control system can advantageously be connected to the real-time data acquisition and control system (SCADA) of the AC network. Thus, the needs and/or operating conditions of the AC network can be identified, so as to differentiate how the injection of power is to be allocated between the at least two injection nodes in order to reduce the total losses of the AC network or contribute to its quality of service.

According to another advantageous embodiment, the architecture comprises voltage and/or frequency measurement means at the first and second nodes, connected to the control system such that it allocates the injection of power between the VSCs according to the measurements carried out.

Thus, the invention substantially entails putting in place an architecture with at least one linear PV installation with a DC network and interconnecting this subassembly at at least two separate points of interconnection with a preferably existing AC power grid. Each point of connection to a node of the AC network is a voltage source converter VSC which can inject 0 to 100% of the maximum power P of the linear PV installations.

The invention therefore involves arbitrating the injection of the electricity produced by the linear PV installations between these two (or more) points of interconnection, VSCs, which therefore form points of injection to the nodes of the AC network in order to reduce the total losses of the AC network, and this being the case while taking account of the needs and/or operating conditions of the latter.

Unlike a PV power plant according to the prior art which is located at a precise point in the power grid and therefore being able to inject only at this point, the architecture according to the invention, with a linear PV installation distributed over a large geographic extent, provides an interconnection at several remote points of the power grid.

By virtue of the architecture according to the invention, the high resilience and reliability of the existing power grid can be preserved while expanding its capacity to integrate large quantities of renewable energy (REn) in the future through linear PV installations.

In the end, an architecture according to the invention exhibits a number of advantages among which there can be cited:
due to the choice of linear installations,
   considerable reduction in the occupation of the ground, as well as a reduction in the construction of HVAC lines;
   increase in PV system penetration capacity to the existing AC power grid;
   reduction in the variation of PV production due to intermittence by virtue of the aggregation of linear installations over a long distance;
improvement in the flexibility of the network, through the possibility of exchanging energy in both directions between a DC network and an AC network;
high reliability and resilience;
improvement in the stability of the AC network;
possibility to maintain continuity of service in the event of a fault or separation from the AC network;
simplification of energy management;
facility to connect DC systems such as storage and/or high power rapid charging stations for EVs and/or electrolysers and fuel cells to the DC network of linear installations;
possibility of coupling with offshore or onshore wind farms, etc;
possibility of effective protection between an AC network and a DC network;
reduction in total losses of the AC network through the optimal distribution of power.

Other advantages and features of the invention will become clearer upon reading the detailed description of example embodiments of the invention, given by way of illustration and in a nonlimiting manner, with reference to the following drawings.

### BRIEF DESCRIPTION OF THE DRAWINGS

FIG. 1 schematically illustrates an electrical architecture according to the invention, as may be installed in the south-east region of France.

FIG. 2 is a block-diagram view of the electrical architecture according to the invention.

FIG. 3 is a schematic view illustrating an architecture according to the invention restricted to two connections per VSC between the DC network and the AC network.

FIG. 4 is a schematic view of the “New England IEEE 39-bus” test network on which tests of power injection from the DC network according to the electrical architecture of the invention have been carried out.

### DETAILED DESCRIPTION

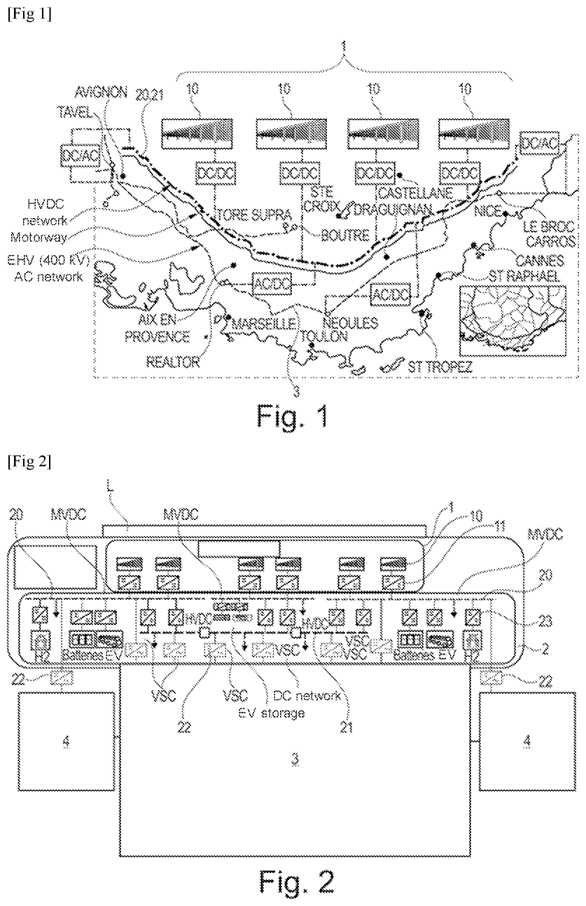

FIG. 1 shows an architecture according to the invention, as may be installed in the south-east region of France.

As illustrated, this electrical architecture comprises a plurality 1 of groups of photovoltaic (PV) panels 10 suitable for producing a maximum total power P. These groups of panels 10 are distributed over hundreds of kilometres in this region by being arranged over ground-based surfaces stretched out over man-made terrain, such as along the edges of railway lines, motorways, etc.

All these groups of panels are electrically parallel-connected by at least one bus 20, 21 of a direct current (DC) network 2 to form a single linear PV installation. This linear PV installation is itself connected to the alternating current (AC) transmission 3 and/or distribution 4 network already existing in this region. All the groups of PV panels are therefore interconnected by at least one DC bus 20, 21. FIG. 2 shows in greater detail the components and possible connection modes according to one embodiment of such an architecture.

In this FIG. 2, the groups of PV panels are distributed along a line L on the ground. The plurality 1 of these PV groups can produce a maximum total power P.

The linear PV installation comprises the plurality of the groups of panels 10 and the DC network 2, which in this case comprises several MVDC buses 20, to which the groups of panels 10 are electrically parallel-connected, each via a DC/DC converter 11.

The DC network also comprises several HVDC buses 21 within the linear PV installation, each connected to one or more MVDC buses 20. The HVDC buses 21 can transmit the DC current over the entire DC network.

Each MVDC bus 20 or HVDC bus 21 of the linear installation is connected to a node of an AC transmission network 3 or to a node of an AC distribution network via a voltage source converter 22.

Preferably, the VSCs 22 are modular multi-level converters (MMCs).

According to the invention, each of the VSCs 22 is suitable for injecting 0 to 100% of the power P into the AC network.

Also according to the invention, a control system for the architecture can distribute the injection of power between all the VSCs 22 according to needs and/or operating conditions of the AC network, so as to reduce the total losses of the latter and/or improve the quality of service over the latter.

As also illustrated in this FIG. 2, the DC network of the architecture comprises several geographically distributed loads, such as high power electric vehicle charging stations (EVs) or electrolysers (H₂) for hydrogen vehicles. Each of these loads is directly connected to the MVDC bus 20 via a DC/DC converter 23.

The DC network can also support several geographically distributed electrical storage means, such as batteries. Each of these storage means is also directly connected to the MVDC bus 20 via a DC/DC converter 23.

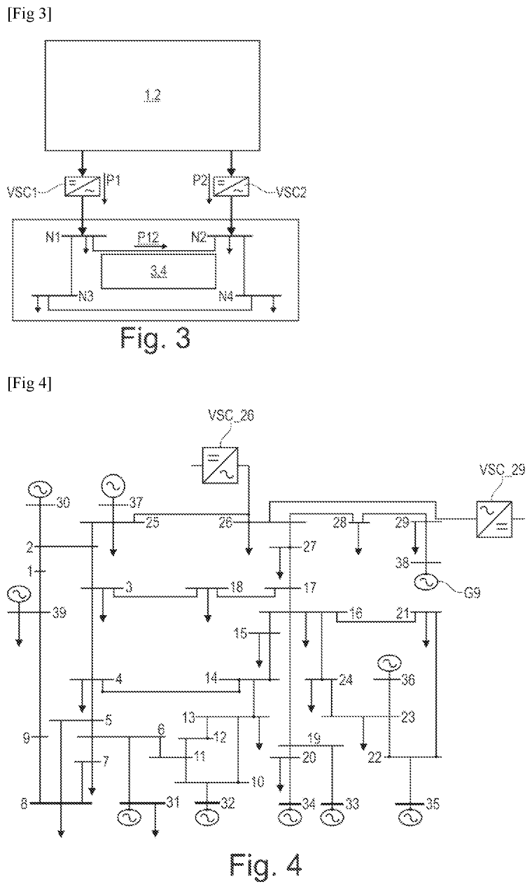

To illustrate the operation of the architecture according to the invention, FIG. 3 shows only two VSCs 22 which perform the coupling between the DC network of the linear installation, connected to the plurality 1 of PV groups 10 and the AC network 3, 4. More specifically, the AC network schematically comprises four nodes N1 to N4, the node N1 being the coupling node of the VSC 21, the node N2 being the coupling node of the VSC 22.

In this configuration, the power injected by each of the converters VSC1 and VSC2 is dependent on the need of the AC network. The transit power P12 between N1 and N2 is in the direction of the arrow indicated in FIG. 3. If the line between N1 and N2 is highly loaded, there is an overload risk.

In that case, according to the invention, the control system for the architecture can reduce the injected power P1 at VSC1 and increase the injected power P2 at VSC2 in order to reduce the overload on the line N1-N2. This control system is preferably the one integrated in the linear PV installation and which drives the operation of the linear PV installation. This has the advantage of local arbitration autonomy for the injected power P1 and P2.

Alternatively, there may be a control system external to the linear PV installation, for example connected with the SCADA control system of the AC network.

Generally, the power between P1 and P2 can be adjusted to reduce the total losses of the AC network or improve its quality of service.

The proposed architecture according to the invention has been validated on the IEEE New England 39-bus AC transmission test network. This AC network, shown schematically in FIG. 4, is a simplification of the New England network in north-eastern USA. It includes 39 nodes, of which 10 are production nodes (numbered 30 to 39), and 46 lines. In particular, at node 29, there is a generator G9.

The total production and consumption of the New England AC network are 6147 MW and 6097 MW respectively.

Software marketed under the name “PowerFactory”, by the company DIgSILENT, has been used to perform the validations on this New England network.

The validation test assumptions were made considering six groups of PV panels all electrically parallel-connected to a DC bus of the linear PV installation. The maximum power of each PV group is 50 MW, i.e. a maximum total power P of 300 MW for the linear installation.

The DC bus is connected to two VSCs which are connected to the New England AC network at nodes 26 and 29, referenced VSC_26 and VSC_29 respectively.

In other words, in the tests, these two VSCs, VSC_26 and VSC_29, inject the production of the six PV groups into the New England AC network.

An overview of the test configuration is shown in FIG. 4.

For the tests, the power of these two VSCs is variable as an arbitrary injection, according to needs and/or operating condition of the AC network.

More specifically, to see the impact of optimal power distribution between the two, VSC_26 and VSC_29, five cases have been tested according to the production power of the generator G9.

For each of these five cases, both VSC_26 and VSC_29 inject thereto the maximum total power P. For each of the cases, to reduce the transit of power over the lines 29-26 and 29-28, some or all of the power P is injected into both VSC_26 and VSC_29 and the total losses of the AC network are evaluated.

From one case to the next, the power injected into each of VSC_26 and VSC_29, denoted by P_VSC_26 and P_VSC_29 respectively, according to the production power of the generator G9 (P_G9), is therefore evaluated.

Table 1 below summarises all the cases, numbered 1 to 5, the power levels and the losses evaluated, with a total power of the linear PV system of 300 MW.

TABLE 1

| | P_G9 | P_VSC_26 | P_VSC_29 | Losses |
|---|---|---|---|---|
| Case | (MW) | (MW) | (MW) | (MW) |
| Case 1 | 730 | 300 | 0 | 57.53 |
| Case 2 | 630 | 200 | 100 | 51.26 |
| Case 3 | 530 | 100 | 200 | 48.7 |
| Case 4 | 430 | 0 | 300 | 50.2 |
| Case 5 | 430 | 270 | 30 | 44.16 |

From this Table 1, the following is apparent:
for Case 5, the total losses are minimal;
the total losses are reduced by about 23% from Case 1 to Case 5;
with optimum distribution of power injected between the two VSCs, P_VSC_26 and P_VSC_29, the losses over the AC network can be optimally reduced.

Consequently, these tests show that if the distribution of power injected on the various VSC coupling points between the linear PV installation DC network, connected to a plurality of groups of PV panels in electrical parallel, and an AC network is optimal, the total losses over the AC network are reduced.

The invention is not limited to the examples which have just been described; in particular, characteristics of the examples illustrated, among variants that are not illustrated, can be combined with one another.

Other variants and embodiments can be considered without thereby departing from the scope of the invention.

### REFERENCES CITED

[1]: T. Athay, R. Podmore, and S. Virmani. “A Practical Method for the Direct Analysis of Transient Stability”. In: IEEE Transactions on Power Apparatus and Systems PAS-98 (2 Mar. 1979), pp. 573-584.
[2]: M. A. Pai. “Energy Function Analysis for Power System Stability”. The Kluwer International Series in Engineering and Computer Science. Power Electronics and Power Systems. Boston: Kluwer Academic Publishers, 1989.

1. An electrical architecture comprising:
at least one linear installation comprising at least one group of photovoltaic panels suitable for producing a maximum total power P, and a direct current network comprising at least one bus, to which the group(s) of PV panels are electrically parallel-connected, each via a DC/DC converter,
an alternating current transmission and/or distribution network,
at least two voltage source converters, one of the two converters connecting the DC bus to a first node of the AC network, the other of the two converters connecting the DC bus to a second node of the AC network, separate from the first node, each of the VSCs being suitable for injecting 0 to 100% of the power P into the AC network,
a control system suitable for allocating the injection of power between the VSCs according to needs and/or operating conditions of the AC network, so as to reduce the total losses of the latter and/or improve the quality of service of the AC network.

2. The architecture according to claim 1, the VSCs being modular multi-level converters.

3. The architecture according to claim 1, the converters being controlled according to a control mode for injected power and for the voltage at the point of connection of the network or according to a control mode for active and reactive power injected at the AC network.

4. The architecture according to claim 1, the bus, to which the group(s) of PV panels are directly electrically parallel-connected, being a medium voltage DC bus.

5. The architecture according to claim 4, comprising several geographically distributed loads, such as high power electric vehicle charging stations or electrolysers for supplying hydrogen-operated vehicles, each connected via a DC/DC converter to the MVDC bus.

6. The architecture according to claim 4, comprising several geographically distributed electrical storage means, including batteries, each connected via a DC/DC converter to the MVDC bus.

7. The architecture according to claim 4, comprising other geographically distributed current sources each connected via a DC/DC converter to the MVDC bus.

8. The architecture according to claim 4, the DC network of the linear installation comprising at least one high voltage DC bus connected to the medium voltage DC bus and to a voltage source converter connected to a node of the AC network.

9. The architecture according to claim 1, the control system being connected to the real-time data acquisition and control system of the AC network.

10. The architecture according to claim 1, comprising voltage and/or frequency measurement means at the first and second nodes, connected to the control system such that it allocates the injection of power between the VSCs according to the measurements carried out.
